(19) United States
(12) Patent Application Publication
(10) Pub. No.: US 2025/0296605 A1
(43) Pub. Date: Sep. 25, 2025

(54) TRAIN SEAT LAYOUT

(71) Applicant: RECARO Aircraft Seating GmbH & Co. KG, Schwaebisch Hall (DE)

(72) Inventors: Daniel FLASHMAN, London (GB); Lawrie BELLWOOD, London (GB); Philipp OSTER, London (GB)

(21) Appl. No.: 18/870,992

(22) PCT Filed: Jun. 1, 2023
(86) PCT No.: PCT/EP2023/064682

§ 371 Date: Dec. 2, 2024

(30) Foreign Application Priority Data
Jun. 3, 2022 (DE) 10 2022 114 181.0

(51) Int. Cl. B61D 1/04; B61D 31/00; B61D 33/00; B61D 37/00

(52) U.S. Cl. CPC B61D 1/04; B61D 31/00; B61D 33/005; B61D 33/0085; B61D 37/00

(57) ABSTRACT

A train seat layout includes a first train seat module comprising a passenger seat and a second train seat module comprising a passenger seat, the train seat modules being arranged adjacently in a longitudinal seat row on a side of an aisle in a passenger compartment, wherein the train seat layout further includes a table unit which is configured to be mounted on a side-panel side and is arranged between the first train seat module and the second train seat module, wherein the passenger seats of the train seat modules are in each case configured to be pivotable between a first seat position and a second seat position, wherein the passenger seat of the first train seat module in its first seat position directly faces towards the table unit, and the passenger seat of the second train seat module in its second seat position directly faces towards the table unit.

### CROSS REFERENCE TO RELATED APPLICATIONS

This application is a U.S. national stage application of PCT/EP2023/064682 filed on Jun. 1, 2023, which is based on and claims priority to German patent application DE 10 2022 114 181.0, filed on Jun. 3, 2022, the contents of which are incorporated herein by reference.

### PRIOR ART

The invention concerns a train seat layout.

A train seat layout with a first train seat module comprising a passenger seat, and with a second train seat module comprising a passenger seat, the train seat modules being arranged adjacently in a longitudinal seat row on a side of an aisle in a passenger compartment, and with a table unit which is configured to be mounted on a side-panel side and is arranged between the first train seat module and the second train seat module, has already been proposed.

The objective of the invention is in particular to provide a generic device having improved properties with regard to space requirement and variability together with high comfort. The objective is achieved according to the invention.

### ADVANTAGES OF THE INVENTION

The invention is based on a train seat layout with a first train seat module comprising a passenger seat, and with a second train seat module comprising a passenger seat, the train seat modules being arranged adjacently in a longitudinal seat row on a side of an aisle in a passenger compartment, with a table unit which is configured to be mounted on a side-panel side and which is arranged between the first train seat module and the second train seat module.

It is proposed that the passenger seats of the train seat modules are in each case configured to be pivotable between a first seat position, which is oriented in a first direction, and a second seat position, which is oriented in a second direction, wherein the passenger seat of the first train seat module in its first seat position directly faces towards the table unit for use, and the passenger seat of the second train seat module in its second seat position directly faces towards the table unit for use. A “train seat layout” is preferably to mean a layout of train seat modules with passenger seats which are configured to be arranged in a passenger compartment of a train car. A “train seat module” is to mean a module comprising at least one passenger seat and further components of a passenger zone. The train seat module is configured to be fixedly mounted on a floor of the train car via suitable fastening elements. The train seat module is realized as a module which defines a passenger zone and for this purpose comprises at least one enclosure unit at least partially separating the passenger zone from a remaining region in the passenger compartment, and comprises at least the passenger seat that is arranged in the passenger zone and further elements of the passenger zone. A “passenger zone” is in this case preferably to mean a region which a passenger in the passenger compartment has personally at his disposal, preferably while the passenger is using the train seat module, wherein preferably all components of the one train seat module are arranged in the passenger zone. The passenger seat of the train seat module is configured to provide a seat for a passenger in the passenger compartment. The passenger seat comprises at least a seat bottom and a backrest. Preferably, the passenger seat comprises at least one armrest. In addition, it would be conceivable that the passenger seat comprises a leg support. In principle, the passenger seat may comprise further attachment parts, such as preferably a headrest. Preferentially the passenger seat is—preferably electromechanically—adjustable between a sitting position and a comfort position, in particular a lying-down position. A “longitudinal seat row” is to mean a row of train seat modules arranged one behind the other, viewed in a longitudinal direction of the train car, respectively of the passenger compartment. Preferably, respectively two longitudinal seat rows of train seat modules are arranged in a passenger compartment, respectively one on each side of an aisle of the passenger compartment that is realized as a central aisle. An “aisle of the passenger compartment” is to mean an aisle between two longitudinal seat rows of train seat modules, via which the train seat modules of the train seat layout are accessible. Preferably, precisely one aisle is provided as a central aisle. Preferentially the aisle of the passenger compartment extends at least substantially parallel to a middle axis of the train car. By a “table unit” is a unit to be understood which forms at least one table surface and for this purpose comprises at least a table base body. The table unit is configured to provide a table surface for a passenger of the passenger seat facing towards the table unit. The table unit may preferably be realized only from the table base body or from the table base body and at least one table element that is fastened thereto. By “attached on a side-panel side” is preferably to be understood that a component, like the table unit, is attached in a region of a lateral side panel of the train car. It is conceivable that the table unit is directly connected to the lateral side panel of the train car. Herein the table unit is preferably directly connected to the lateral side panel of the train car via a force-fitting and/or form-fitting connection. For example, the table unit is directly screwed with the lateral side panel. It is also conceivable that the table unit is connected to the side panel via a support means. In principle it is also conceivable that the table unit that is attached on a side-panel side is mounted on the floor via a support structure in a proximity of the lateral side panel. Herein it is conceivable that the support structure directly adjoins the side panel. The table unit is connected to the floor of the passenger compartment via the support structure. Forces acting on the table unit are directly introduced into the floor via the support structure. By the table unit being arranged between the two adjacent train seat modules is preferably to be understood that the table unit is arranged in a region between the two train seat layouts. The passenger seats are fixedly lockable in their seat positions. The passenger seats are in their seat positions oriented towards a lateral side panel and away from the aisle. The sitting direction of the passenger seats is in the seat positions oriented away from the aisle towards the lateral side panel. A “sitting direction of a passenger seat” is to mean a direction that is oriented parallel to a mounting plane and at least substantially perpendicular to a backrest surface formed by the backrest. The sitting direction is preferably oriented parallel to a longitudinally-extending middle axis of the passenger seat. By a “mounting plane” is the plane to be understood on which the passenger seat, respectively the entire train seat module, is mounted. The mounting plane is realized as a floor of the passenger compartment of the train car. By a “seat position oriented in a first direction” is a seat position to be understood in which a sitting direction of the respective passenger seat has a component that runs parallel to the first direction. Herein the sitting direction itself does not run parallel to the first direction. By a “seat position oriented in a second direction” is a seat position to be understood in which a sitting direction of the respective passenger seat has a component that runs parallel to the second direction. Herein the sitting direction itself does not run parallel to the second direction.

“The passenger seats being pivotable between the two seat positions” is to mean that a passenger seat is adjustable between the two seat positions via an adjusting movement that comprises at least a rotation of the passenger seat. In principle, it is conceivable that an adjusting movement in which the passenger seat is adjusted comprises only a rotational movement. In principle, it is also conceivable that the adjusting movement in which the passenger seat is adjusted comprises a rotational, pivoting and/or linear movement. Preferably the train seat module comprises an enclosure unit which at least partially surrounds the passenger seat of the train seat module and separates it from a remaining portion of the passenger compartment. In principle, however, it is also conceivable that the train seat module does not comprise an enclosure unit and the passenger zone laterally of and behind the passenger seat is not additionally separated from a remaining portion of the passenger compartment. “Configured” is in particular to mean specifically designed and/or equipped. By an object being configured for a specific function is in particular to be understood that the object fulfils and/or performs this specific function in at least one application state and/or operation state. An implementation according to the invention advantageously allows using adjacently-arranged passenger seats of the respective train seat modules individually or together as a seat group. The implementation according to the invention allows providing an especially advantageously flexible train seat layout that is comfortable for passengers. Especially advantageously, the implementation according to the invention allows providing an advantageously comfortable and flexible train seat layout requiring little space.

It is further proposed that the passenger seats are configured to be pivoted between their first seat position and their second seat position by an angle that is in an angle range of 90 degrees to 120 degrees. Preferably the passenger seats are in their seat positions oriented in the train car at an angle α. By a passenger seat being oriented in the train car at an angle α is to be understood that the passenger seat is mounted in the train car so as to be pivoted by the angle α with respect to the train car middle axis. The angle α by which the passenger seat is pivoted is measured between the sitting direction, i. e. the longitudinally-extending middle axis of the passenger seat, and the train car middle axis. A passenger seat is preferably pivoted by an angle α in an angle range of 25 degrees to 80 degrees, particularly preferably in an angle range of 30 degrees to 40 degrees, with respect to the train car middle axis. In a preferred implementation, the angle α by which the passenger seat is pivoted with respect to the train car middle axis is 35 degrees. Depending on the angle α at which the passenger seats are arranged in their seat positions, the angle by which the passenger seats are pivoted between their seat positions is of different magnitudes. As a result, a particularly advantageous implementation of the train seat modules is achievable.

Furthermore, it is proposed that the passenger seat of the first passenger seat module in its first seat position and the passenger seat of the second train seat module in its second seat position form a conjoint seat group, wherein the table unit arranged between them can be used from both passenger seats of the conjoint seat group. A “conjoint seat group” is preferably to mean a group of passenger seats which face towards one another and which form a conjoint passenger zone. The table unit arranged between the two passenger seats of the conjoint seat group can be used at the same time and jointly by passengers on both passenger seats of the seating group. This allows providing a seat group for two passengers travelling together in an especially simple manner.

It is also proposed that the table unit comprises a table base body, forming a main table surface and having a first table front edge that is oriented at least substantially orthogonally to the passenger seat of the first train seat module in its first seat position, and having a second table front edge that is oriented at least substantially orthogonally to the passenger seat of the second train seat module in its second seat position. A “table front edge” is preferably mean an edge which faces towards a corresponding passenger seat from which the table unit can be used. In this way, the table unit can be realized especially advantageously for the use from both passenger seats.

Moreover, it is proposed that in a top view the table base body has a trapezoid shape or a triangle shape. The triangle shape or trapezoid shape implements a basic shape of the table base body. In such an implementation, corners of the table base body are preferably rounded or flattened. This allows realizing the table base body, and thus the table unit, in an especially advantageous manner.

It is further proposed that the table unit comprises a first adjustable table element, which is arranged at the table base body and is adjustable into a use position towards the passenger seat of the first train seat module in its first seat position, and/or comprises a second adjustable table element, which is arranged at the table base body and is adjustable into a use position towards the passenger seat of the second train seat module in its second seat position. By an “adjustable table element” is preferably a table element to be understood that is additional to the table base body and in a use position forms an additional table surface, enlarging the main table surface of the main table element, in particular in a direction towards the corresponding passenger seat. The adjustable table element is preferably pivotable, linearly displaceable, or movable in a combined pivoting and linear movement between its stowage position and its use position. This allows providing an especially advantageous table unit, the table surface of which can be advantageously enlarged towards the respectively allocated passenger seats in order to increase comfort for a passenger.

Furthermore, it is proposed that the train seat layout comprises a further table unit, which is arranged after the first train seat module in the second direction, wherein the passenger seat of the first train seat module in its second seat position directly faces towards the further table unit for use. The further table unit is here preferably realized identically to the first table unit. The train seat layout comprises per longitudinal seat row one table unit more than passenger seats. As a result, respectively one table unit is allocated to each passenger seat in each of its seat positions. This advantageously allows enlarging the train seat layout.

It is moreover proposed that the train seat layout comprises a further table unit, which is arranged after the second train seat module in the first direction, wherein the passenger seat of the second train seat module in its first seat position directly faces towards the further table unit for use. As a result, respectively one table unit is allocated to each passenger seat in each of its seat positions. This advantageously allows enlarging the train seat layout.

Furthermore, it is proposed that the passenger seat of the train seat area is realized as a lying-down seat, which is adjustable between a sitting position and at least a lying-down position. Preferably the passenger seat is realized as a full-flat seat. By a “full-flat seat” is preferably a passenger seat to be understood which is, in particular electromechanically, transferable from the upright sitting position into the lying-down position and in the lying-down position forms an at least substantially planar lying-down surface. Preferably the at least substantially planar lying-down surface is oriented at least substantially parallel to a mounting plane. Particularly preferentially, at least a seat bottom of the passenger seat and a backrest of the passenger seat are in the lying-down position oriented at least substantially parallel to the mounting plane on which the passenger seat is mounted. Preferably, in the lying-down position the seat bottom of the passenger seat and the backrest of the passenger seat have a common support surface oriented at least substantially parallel to the mounting plane. The passenger seat is configured to provide in the lying-down position the substantially planar lying-down surface on which an average passenger can lie in stretched-out fashion. In principle, it is also conceivable that the planar lying-down surface is not oriented parallel to a mounting plane. In principle, it is conceivable that the planar lying-down surface of the passenger seat is inclined at an angle of 10 degrees to 20 degrees relative to the mounting plane. This allows providing an inclined planar lying-down surface which, with the same space requirement, has an advantageously greater length than a lying-down surface that is oriented parallel to the mounting plane. An “at least substantially planar lying-down surface” is to mean a lying-down surface which is preferably continuously planar, but in principle it is also conceivable that an angle β different from 180 degrees is spanned between a backrest surface of the backrest and a seat surface of the seat bottom, which in the lying-down position of the passenger seat form the lying-down surface. The angle β may herein preferably be between 150 degrees and 179 degrees. This allows realizing the passenger seat in an especially advantageous and comfortable manner.

Beyond this, it is proposed that the train seat layout comprises a foot support element, which is arranged below the table unit and is configured to provide a foot support region for the passenger seats of the first and second train seat modules. A “foot support element” preferably is to mean an element which forms an upholstered region, realizing an ottoman, respectively a bed extension, for at least one, preferably two, allocated passenger seats. The foot support element is configured to provide a region which, in a sitting position of the corresponding passenger seat forms a foot support region for a passenger and/or in a lying-down position of the corresponding passenger seat enlarges the lying-down surface of the passenger seat. This allows providing a passenger seat having an especially comfortable lying-down surface.

It is further proposed that the passenger seat of the train seat area is realized as a full-flat lying-down seat and is configured to provide an at least substantially planar lying-down surface with a bed length of at least 170 cm. This allows providing a passenger seat having an especially long lying-down surface, and thus advantageously increasing comfort.

It is also proposed that the train seat layout comprises a stowage and/or deposition unit, which is arranged laterally next to the passenger seat of the train seat module and is configured to be attached on a side-panel side and to provide a stowage region and/or a deposition surface. A “stowage and/or deposition unit” is preferably to mean a region or a unit in which utensils and literature can be stowed. A stowage and/or deposition unit may preferably be realized as a storage compartment, as a deposition rack, as a closable stowage compartment and/or as a fastening element, such as for example an elastic tensioning strap. This allows realizing a train seat module in an especially advantageous manner.

Beyond this, it is proposed that the passenger seats of the train seat modules are in each case configured to be oriented towards a side-panel side in their seat positions. “Oriented towards a side-panel side” is to mean that the passenger seats are realized with their sitting direction towards the lateral side panel. This allows realizing the train seat module in an especially advantageous manner.

It is furthermore proposed that the train seat module comprises an enclosure unit, which at least partially delimits the one passenger zone of the train seat module behind and laterally of the passenger seat, and is configured to be pivoted together with the passenger seat during an adjustment between the first seat position and the second seat position. By an “enclosure unit” is preferably a unit to be understood which is formed from at least one element, in particular from at least one enclosure element, and which physically separates the passenger zone permanently from a portion of the passenger compartment, in particular from a further passenger zone that is arranged behind the passenger seat, and from the central aisle, at least up to a maximum height. The enclosure unit is realized as a separating unit, which separates the train seat area from the central aisle and from at least one passenger zone. The enclosure unit is preferably realized in a substantially V-shaped manner and extends behind the passenger seat and at least partially laterally of the passenger seat, at least as far as a region of the seat bottom. In principle, it is also conceivable that the enclosure unit is realized substantially in a U-shape or in a trapezoid shape. The V-shaped, U-shaped or trapezoid-shaped implementation of the enclosure unit is as viewed in a top view. Particularly preferentially, in a top view the enclosure unit has a hexagonal basic shape. The enclosure unit is fixedly connected with the corresponding passenger seat of the train seat module and is adjustable together with the passenger seat between the two seat positions of the passenger seat. In the two seat positions the enclosure unit has identical relative positions with respect to the corresponding passenger seat of the train seat module. As a result, the train seat module can be realized in an especially advantageous manner and a passenger can be provided with an advantageously high level of privacy.

Moreover, it is proposed that the train seat layout comprises at least two further train seat modules and a table unit, which are arranged on a second side of the aisle of the passenger compartment and face towards a second side panel. The further train seat modules and table units form a further longitudinal seat row in the train seat layout in the passenger compartment. This allows providing an especially advantageous train seat layout.

The train seat layout according to the invention shall not be limited to the above-described application and implementation. In particular, in order to fulfil a functionality that is described here, the train seat layout according to the invention may comprise a number of individual elements, components and units that differs from a number given here.

### DRAWINGS

Further advantages will become apparent from the following description of the drawings. An exemplary embodiment of the invention is illustrated in the drawings. The drawings, the description and the claims contain numerous features in combination. Someone skilled in the art will purposefully also consider the features individually and will find further expedient combinations.

In the drawings:

FIG. 1 shows a schematic illustration of a portion of a passenger compartment of a train car, with a portion of a train seat layout according to the invention comprising a first train seat module and comprising a second train seat module, which with their passenger seats form a conjoint seat group with a jointly used table unit,

FIG. 2 shows a further schematic illustration of a portion of the train seat layout with train seat modules in an individual arrangement,

FIG. 3 shows a schematic view of the train seat module in an individual arrangement, with the passenger seat in a comfort position,

FIG. 4 shows a schematic view of the train seat module in an individual arrangement, with a passenger seat realized as a full-flat seat in a lying-down position,

FIG. 5 shows a schematic top view of the passenger compartment in a train car, with a train seat layout comprising train seat modules in different seat positions,

FIG. 6 shows a further schematic top view of the passenger compartment in a train car, with a train seat layout comprising train seat modules in different seat positions,

FIG. 7 shows a schematic top view of a portion of the train seat layout, with a passenger seat of the first train seat module in a first seat position and the passenger seat of the second train seat module in a first seat position, and

FIG. 8 shows a schematic top view of a portion of the train seat layout, with a passenger seat of the first train seat module in a first seat position and the passenger seat of the second train seat module in a second seat position, in a seat group with a jointly used table unit.

### DESCRIPTION OF THE EXEMPLARY EMBODIMENT

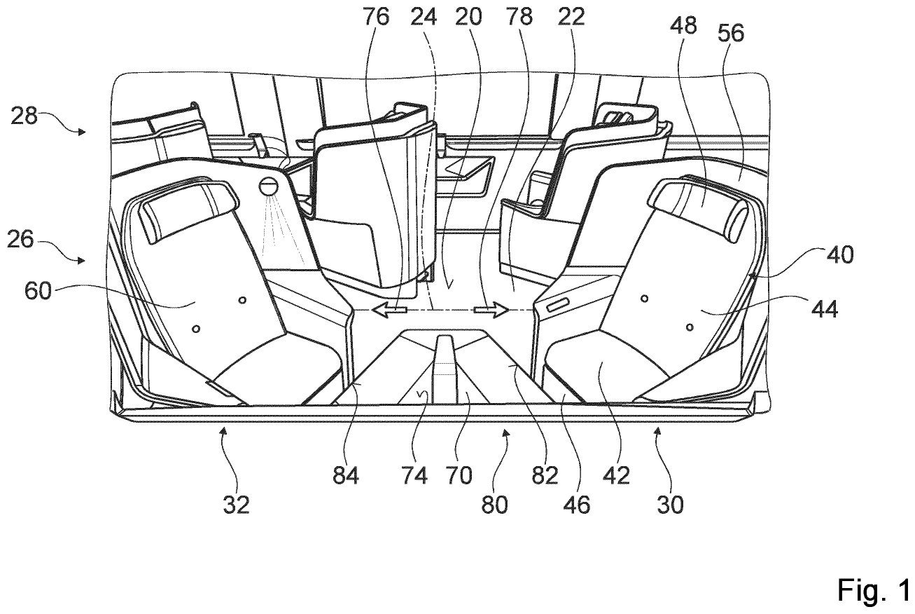

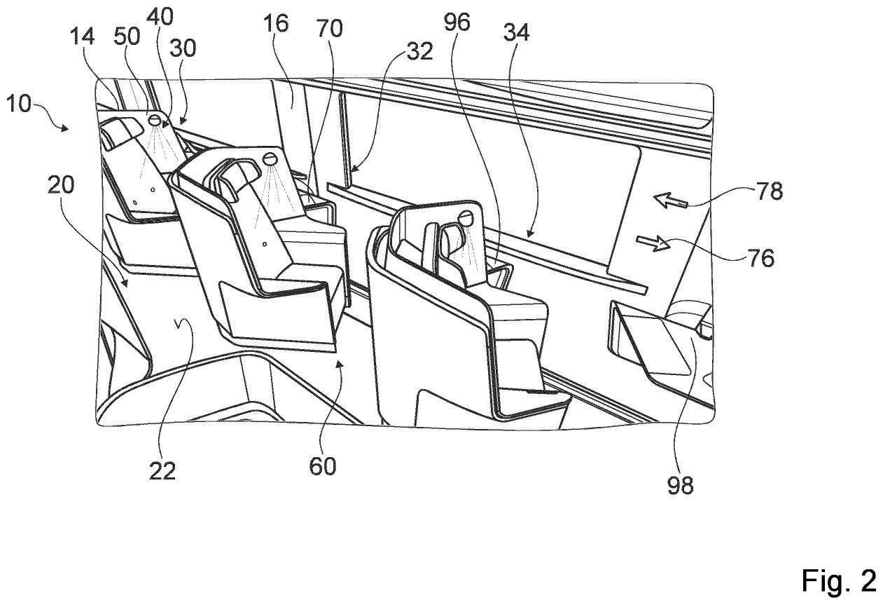

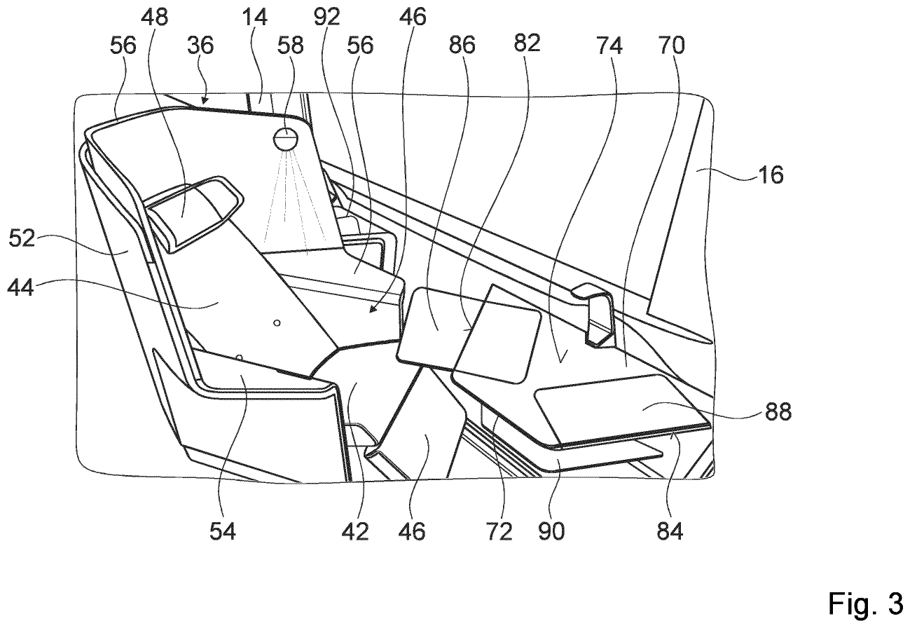

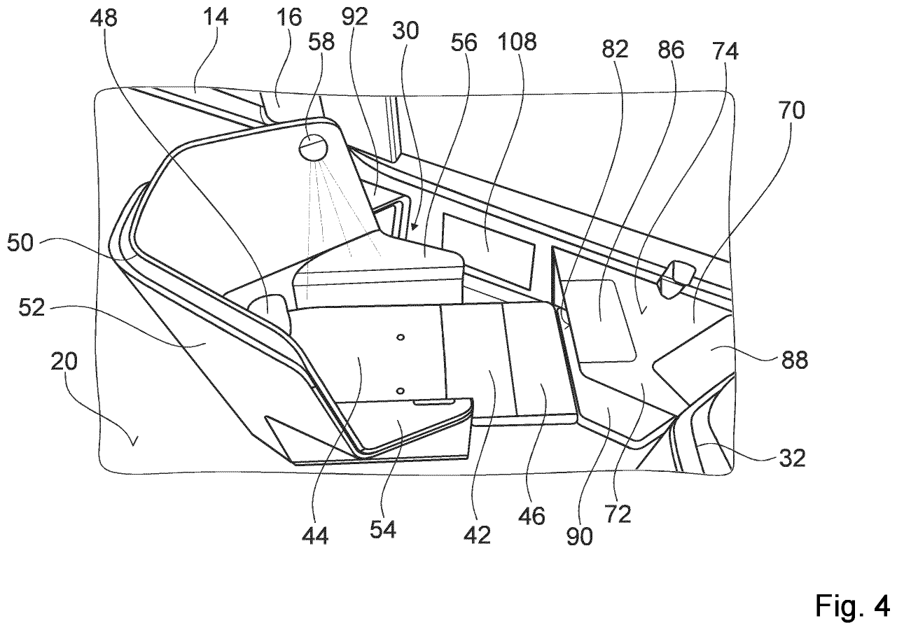

FIGS. 1 to 8 show a train seat layout 10 according to the invention. The train seat layout 10 is part of a passenger compartment 12 according to the invention. The passenger compartment 12 is part of a train car 14. The train seat layout 10 is configured to be arranged in the passenger compartment 12 of the train car 14. The train car 14 comprises two opposite-situated lateral side panels 16, 18. The side panels 16, 18 form longitudinal walls of the train car 14. The side panels 16, 18 delimit the passenger compartment 12 laterally. The lateral side panels 16, 18 preferably comprise window panes, which are not illustrated in detail. The train car 14 has a floor 20. The floor 20 of the train car 14 forms a floor of the passenger compartment 12. The floor 20 forms a mounting plane of the passenger compartment 12. The passenger compartment 12 forms an aisle 22. The aisle 22 of the passenger compartment 12 is realized as a central aisle. The aisle 22, which is realized as a central aisle, is arranged centrally between the two lateral side panels 16, 18. The train car 14 forms a train car middle axis 24. The train car middle axis 24 is a longitudinal axis of the train car 14. The train car middle axis 24 runs parallel to the lateral side panels 16, 18. The aisle 22 is arranged parallel to, preferably coaxially with, the train car middle axis 24. The train seat layout 10 comprises two longitudinal seat rows 26, 28. The longitudinal seat rows 26, 28 are respectively arranged on a side of the aisle 22 in the passenger compartment 12. The first longitudinal seat row 26 is arranged on a first, left-hand side of the aisle 22. The second longitudinal seat row 28 is here arranged on a second, right-hand side of the aisle 22.

The train seat layout 10 has a first direction 76. The first direction 76 is realized as a first direction of the passenger compartment 12, in particular of the train car 14. The first direction 76 runs parallel to the train car middle axis 24. The first direction 76 runs in a horizontal plane which is oriented parallel to the floor 20. The first direction 76 of the train seat layout 10 faces towards a first end of the passenger compartment 12, respectively of the train car 14, i.e. is oriented towards the first end of the passenger compartment 12, respectively of the train car 14. The first direction 76 is oriented towards a front end of the train car 14. The train seat layout 10 has a second direction 78. The second direction 78 is realized as a second direction of the passenger compartment 12, in particular of the train car 14. The second direction 78 runs parallel to the train car middle axis 24. The second direction 78 runs in a horizontal plane which is oriented parallel to the floor 20. The second direction 78 of the train seat layout 10 faces towards a second end of the passenger compartment 12, respectively of the train car 14, i.e. is oriented towards the second end of the passenger compartment 12, respectively of the train car 14. The second direction 78 is oriented towards a rear end of the train car 14. The second direction 78 is opposed to the first direction 76. The second direction 78 is rotated by 180 degrees with respect to the first direction 76. The first direction 76 and the second direction 78 are configured to define orientations of objects in the train seat layout 10 in more detail.

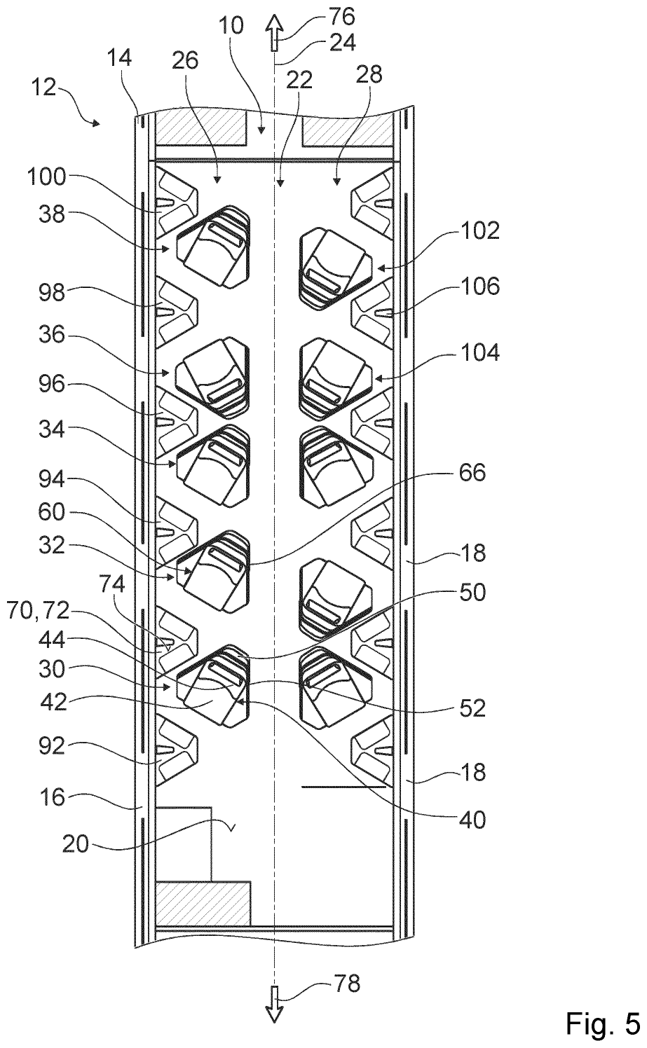

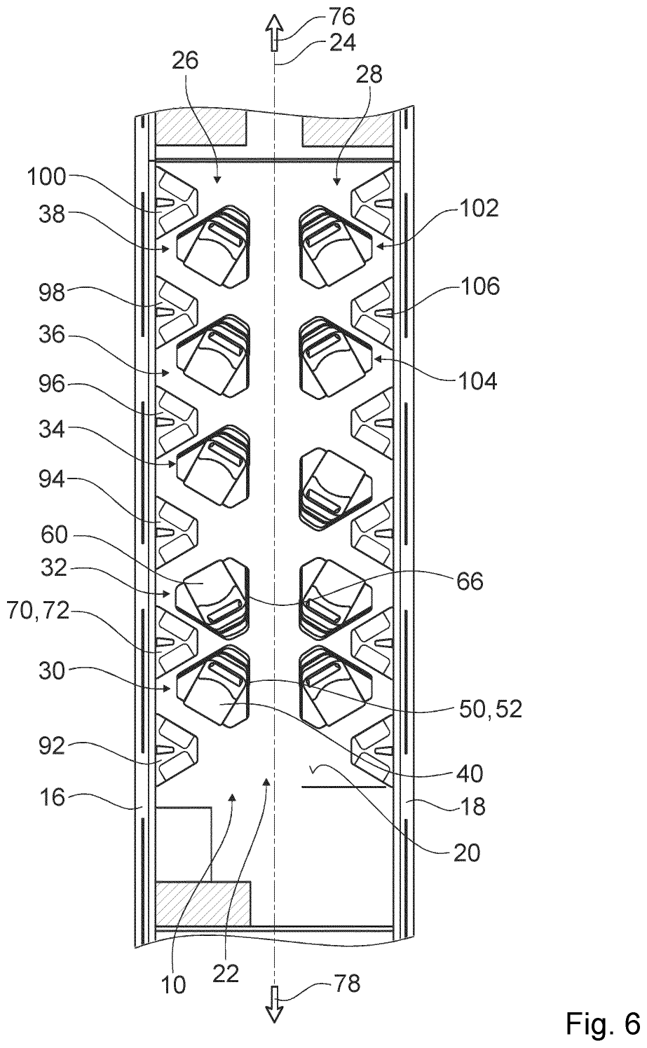

The train seat layout 10 comprises a first train seat module 30. The train seat layout 10 comprises a second train seat module 32. The second train seat module 32 is arranged neighboring to the first train seat module 30. The first train seat module 30 and the second train seat module 32 are arranged directly next to each other in the one longitudinal seat row 26. In the train seat layout 10 shown by way of example in FIGS. 5 and 6, three further train seat modules 34, 36, 38 are provided in the one longitudinal seat row 26 of the train seat layout 10. In principle, it would also be conceivable that the train seat layout 10 comprises a different number of train seat modules 30, 32, 34, 36, 38, wherein the train seat layout 10 comprises at least the two train seat modules 30, 32. The further train seat modules 34, 36, 38 are realized substantially in the same manner as the train seat modules 30, 32, which will be described in detail below. A detailed description of the further train seat modules 34, 36, 38 may be gathered from the following description of the train seat modules 30, 32.

The first train seat module 30 comprises a passenger seat 40. The first train seat module 30 at least partially delimits a passenger zone for a passenger. The passenger seat 40 is configured to provide a seating for a passenger. The passenger seat 40 is arranged in the passenger zone of the train seat module 30. The passenger seat 40 comprises a seat bottom 42 and a backrest 44. The passenger seat 40 comprises a mounting unit, which is not illustrated in detail and via which the passenger seat 40 is mounted on the floor 20. The seat bottom 42 and the backrest 44 are mounted on the mounting unit. The passenger seat 40 is adjustable between an upright sitting position and at least one comfort position. The passenger seat 40 is realized as a lying-down seat. The passenger seat 40 may be adjusted from the sitting position into a lying-down position. In the lying-down position, the passenger seat 40 forms a lying-down surface. In the lying-down position, the seat bottom 42 and the backrest 44 form a lying-down surface. It is conceivable that the backrest 44 and the seat bottom 42 are inclined relative to each other in the lying-down position and do not form a completely planar lying-down surface. The passenger seat 40 is preferably realized as a full-flat seat. The passenger seat 40 realized as a full-flat seat is configured to form a substantially planar lying-down surface in a lying-down position. The passenger seat 40 realized as a full-flat seat is configured to provide a planar lying-down surface with a bed length of at least 170 cm. The seat bottom 42 and the backrest 44 of the passenger seat 40 are arranged parallel to each other in the lying-down position and together form the lying-down surface. The passenger seat 40 preferably comprises a leg support element 46. The leg support element 46 is arranged pivotably at a front end of the seat bottom 42. The mounting unit comprises an actuator module, which is not illustrated in detail and via which the elements of the passenger seat 40 mounted on the mounting unit, such as the seat bottom 42, the backrest 44 and the leg support element 46, are adjustable between their sitting position and their lying-down position. For this purpose, the actuator module comprises several actuators, which are preferably electronically controllable. The passenger seat 40 is electronically adjustable between its upright sitting position and its comfort position and its lying-down position. In principle, it is also conceivable that the passenger seat 40 is manually adjustable. For this purpose, it would in particular be conceivable that the passenger seat comprises one or several manually actuatable actuators, such as for example gas compression springs, which in an unactuated state fix the passenger seat 40 in a current position and in an actuated state permit an adjusting movement of the passenger seat 40. Herein an adjustment of the passenger seat 40 between its sitting position and its comfort position or its lying-down position would be brought about by an adjusting force exerted by a passenger onto the passenger seat 40. The passenger seat 40 further comprises a headrest 48. The headrest 48 is connected in an upper region of the backrest 44 of the passenger seat 40.

The train seat module 30 comprises an enclosure unit 50. The enclosure unit 50 at least partially delimits the passenger zone of the train seat module 30 behind and laterally of the passenger seat 40. The enclosure unit 50 is realized by an enclosure element 52. The enclosure element 52 forms a partition wall. The enclosure unit forms a separating unit which delimits the passenger zone of the train seat module 30 to the rear and laterally. The enclosure element 52 extends, from a region behind the passenger seat 40, in each case as far as a region laterally of the passenger seat 40. The enclosure element 52 of the enclosure unit 50 has a V-shaped basic shape. The enclosure element 52 extends from a region close to the ground up to a height level above the backrest 44 of the passenger seat 40 in an upright sitting position. In this way the enclosure element 52 forms a visual protection behind the passenger seat 40, which extends as far as above the backrest 44. In this way the enclosure element 52 creates an especially advantageous delimitation with respect to a remaining portion of the passenger compartment 12. The enclosure element 52 comprises a rear wall region, which is arranged behind the backrest 44 of the passenger seat 40 and is oriented substantially parallel to the backrest 44, i.e. to a transverse direction of the passenger seat 40. The enclosure element 52 has two side wall regions. The side wall regions delimit the enclosure unit 50 laterally. The side wall regions in each case extend from a lateral end of the rear wall region to the front into a region laterally of the passenger seat 40. The side wall regions are oriented obliquely relative to each other. Viewed from the rear wall region, the side wall regions of the enclosure element 52 extend away from each other frontwards. The side wall regions of the enclosure element 52 include an opening angle which converges behind the passenger seat 40.

The enclosure element 52 preferably forms armrests 54, 56 in its side wall regions. Herein the armrests 54, 56 may preferably be formed at least partially by the enclosure element 52. Preferably the armrests 54, 56 in each case comprise a cushion element cushioning a support surface of the armrests 54, 56. In principle, it is also conceivable that the armrests 54, 56 are realized separately from the enclosure element 52. Furthermore, the first train seat module 30 advantageously comprises a lighting element 58, which is arranged on an inner side of the enclosure element 52. The lighting element 58 may be realized, for example, as a reading lamp.

The second train seat module 32 comprises a passenger seat 60. The second train seat module 32 at least partially delimits a passenger zone for a passenger of the train seat module 32. The passenger seat 60 is configured to provide a seating for a passenger. The passenger seat 60 is arranged in the passenger zone of the second train seat module 32. The passenger seat 60 comprises a seat bottom 62 and a backrest 64. The passenger seat 60 comprises a mounting unit, which is not illustrated in detail and via which the passenger seat 60 is mounted on the floor 20. The passenger seat 60 is realized as a lying-down seat. The passenger seat 60 is adjustable from the sitting position into a lying-down position. In the lying-down position, the passenger seat 60 forms a lying-down surface. The passenger seat 60 is preferably realized as a full-flat seat. The passenger seat 60 of the second train seat module 32 is realized substantially in the same manner as the passenger seat 40 of the first train seat module 30. Therefore the passenger seat 60 of the second train seat module 32 will not be described in detail here. The description of the passenger seat 40 of the first train seat module 30 can be applied accordingly. The second train seat module 32 comprises an enclosure unit 66. The enclosure unit 66 at least partially delimits the passenger zone of the train seat module 32 behind and laterally of the passenger seat 60. The enclosure unit 66 is realized by an enclosure element 68. The enclosure element 68 forms a partition wall. The enclosure unit 66 of the second train seat module 32 is likewise realized in a manner equivalent to the enclosure unit 50 of the first train seat module 30.

The train seat layout 10 comprises a table unit 70. The table unit 70 is arranged between the first train seat module 30 and the second train seat module 32. The table unit 70 is arranged on a side-panel side. The table unit 70 is arranged in a proximity of the first lateral side panel 16. Preferably the table unit 70 is directly connected to the first lateral side panel 16. The table unit 70 is fixedly mounted to the side panel 16 by means of a screw connection. In principle, it is also conceivable that the table unit 70 is connected to the side panel 16 in a different way in a force-fitting, materially-bonded and/or form-fitting manner. In principle, it is also conceivable that the table unit 70 is mounted on the floor 20 of the train car 14 in a proximity of the side panel 16, via a support structure. The table unit 70 is arranged centrally between the passenger seats 40, 60 of the two train seat modules 30, 32. Measured parallel to the train car middle axis 24, the table unit 70 has an equal distance to a center point of the passenger seats 40, 60 of the two train seat modules 30, 32 between which the table unit 70 is arranged, in particular when they face towards the table unit 70. Viewed in the first direction 76, the table unit 70 is arranged after the passenger seat 40 of the first train seat module 30. Viewed in the first direction 76, the table unit 70 is arranged in front of the passenger seat 60 of the second train seat module 32. Viewed in the second direction 78, the table unit 70 is arranged in front of the passenger seat 40 of the first train seat module 30. Viewed in the second direction 78, the table unit 70 is arranged behind the passenger seat 60 of the second train seat module 32. The table unit 70 comprises a table base body 72. The table base body 72 forms a main table surface 74 of the table unit 70. In a top view, the table base body 72 essentially has a trapezoid shape. A larger side of the table base body 72 faces towards the side panel 16. A narrow side of the trapezoid-shaped table base body 72 faces away from the side panel. In principle, it would also be conceivable that in a top view the table base body 72 essentially has a triangle shape.

The passenger seats 40, 60 of the train seat modules 30, 32 are configured to be pivotable between a first seat position, which is oriented in the first direction 76, and a second seat position, which is oriented in the second direction 78. The passenger seats 40, 60 of the train seat modules 30, 32 can be oriented in the first seat position, which is oriented in the first direction 76m and in the second seat position, which is oriented in the second direction 78. The passenger seats 40, 60 of the train seat modules 30, 32 can be locked in the first seat position and in the second seat position. In a seat position oriented in the respective direction 76, 78, the passenger seat 40, 60 has an overall orientation in this direction 76, 78. A backrest 44, 64 of the respective passenger seat 40, 60 is generally oriented in the respective direction 76, 78 in a first seat position, respectively in a second seat position. A sitting direction of the respective passenger seat 40, 60 is generally oriented in the respective direction 76, 78 in a first seat position, respectively in a second seat position. The sitting direction of the respective passenger seat 40, 60 has in the first seat position a component in the first direction 76. The sitting direction of the respective passenger seat 40, 60 has in the second seat position a component in the second direction 78. Herein the passenger seats 40, 60 are in the first sitting direction, respectively in the second sitting direction, not oriented parallel to the first direction 76, respectively the second direction 78. The sitting directions of the passenger seats 40, 60 are in the seat positions respectively arranged obliquely relative to the directions 76, 78. The sitting directions of the passenger seats 40, 60 are in the seat positions not oriented parallel to the respective direction 76, 78.

The passenger seats 40, 60 of the train seat modules 30, 32 are mounted pivotably on the floor 20 of the passenger compartment 12. The passenger seats 40, 60 of the train seat modules 30, 32 are preferably pivotably connected to the floor 20 via their mounting unit. The passenger seats 40, 60 of the train seat modules 30, 32 can be adjusted between their two seat positions via their mounting unit. For this purpose, the mounting units of the passenger seats 40, 60 preferably in each case comprise an adjustment mechanism. The passenger seats 40, 60 of the train seat modules 30, 32 are adjustable in an adjusting movement between the first seat position and the second seat position. The adjusting movement via which the passenger seats 40, 60 of the train seat modules 30, 32 are adjustable between the two seat positions is preferably realized as a rotational movement. Preferably the adjusting movement is realized as a purely rotational movement. The adjusting movement that is realized as a rotational movement rotates the corresponding passenger seat 40, 60 around a rotation center situated in a region below the passenger seat 40, 60. Preferably the rotation center, around which the corresponding passenger seat 40, 60 is rotated during the adjusting movement, is situated in a seat center of the corresponding passenger seat 40, 60. In principle, it is also conceivable that during an adjustment between their two seat positions, the passenger seats 40, 60 of the train seat modules 30, 32 are pivoted around an eccentric rotation axis that is situated outside the passenger zone. Moreover, it is also conceivable that an adjusting movement of the passenger seats 40, 60 of the train seat modules 30, 32 between the seat positions is realized as a combined movement comprising at least a rotation and a linear displacement. For example, it would be conceivable that firstly the respective passenger seat 40, 60 is linearly traversed backwards from its one seat position, is then rotated around a corresponding rotation axis and after this is linearly traversed forward into its other seat position. The corresponding adjusting mechanism of the mounting units of the passenger seats 40, 60 comprises corresponding rotary bearings and/or linear bearings, for example guide rails, for an adjustment of the passenger seats 40, 60 between the seat positions.

The passenger seats 40, 60 of the train seat modules 30, 32 are configured to be pivoted between their first seat position and their second seat position by an angle that is in an angle range of 90 degrees to 135 degrees. In the exemplary embodiment shown, the angle by which the passenger seats 40, 60 are pivoted between their first seat position and their second seat position is 120 degrees. In their seat positions the passenger seats 40, 60 of the train seat modules 30, 32 respectively include an angle α with the train car middle axis 24. The passenger seats 40, 60 have the angle α relative to the train car middle axis 26 with their seat middle axes, respectively their seat directions. In their seat positions, the passenger seats 40, 60 of the train seat modules 30, 32 preferably include an angle α of 120 degrees. In their first seat position and in their second seat position the passenger seats 40, 60 of the train seat modules 30, 32 respectively include at least an angle α having the same absolute value with respect to the train car middle axis 24. In their seat positions, the passenger seats 40, 60 of the train seat modules 30, 32 are in each case configured to be oriented towards a side-panel side. In their seat positions, the passenger seats 40, 60 of the train seat modules 30, 32 are in each case oriented towards the corresponding side panel 16. In the seat positions, a sitting direction of the passenger seats 40, 60 of the train seat modules 30, 32 respectively points towards the corresponding side panel 16. The enclosure units 50, 66 of the train seat modules 30, 32 are in each case fixedly coupled with the respective passenger seat 40, 60. During an adjustment between the first seat position and the second seat position, the enclosure units 50, 66 are also pivoted with the corresponding passenger seat 40, 60.

The passenger seats 40, 60 of the train seat modules 30, 32 are in each case lockable in their seat positions. The passenger seats 40, 60 of the train seat modules 30, 32 are lockable in their seat positions in an operationally safe manner. For an adjustment of the passenger seats 40, 60, first of all a corresponding adjusting mechanism must be unlocked. Preferably, an adjusting mechanism of a passenger seat 40, 60 is only unlockable by authorized staff. For this purpose, suitable safety measures, such as suitable locks or electronic safety mechanisms, are preferably provided. In principle, it would also be conceivable that an adjusting mechanism of a passenger seat 40, 60 can also be unlocked by a passenger. For example, a simple lever mechanism could be provided for an unlocking, respectively locking, of the adjusting mechanism of the respective passenger seat 40, 60.

The passenger seat 40 of the first train seat module 30 in its first seat position directly faces towards the table unit 70 for use. In its first seat position, in which it is oriented in the first direction 76, the passenger seat 40 of the first train seat module 30 is directly oriented towards the table unit 70. In its first seat position, the passenger seat 40 that is directly oriented towards the table unit 70 for use is oriented with its sitting direction directly towards the table unit 70. In the first seat position of the passenger seat 40 of the first train seat module 30, the table unit 70 is arranged directly in front of the passenger seat 40. A passenger sitting on the passenger seat 40 of the first train seat module 30 can directly use the table unit 70 in the first seat position of the passenger seat 40.

In its second seat position, the passenger seat 60 of the second train seat module 32 directly faces towards the table unit 70 for use. In its second seat position, in which it is oriented in the second direction 78, the passenger seat 60 of the second train seat module 32 is oriented directly towards the table unit 70. In its second seat position, the passenger seat 60 that is directly oriented towards the table unit 70 for use is oriented with its sitting direction directly towards the table unit 70. In the second seat position of the passenger seat 60 of the second train seat module 32, the table unit 70 is arranged directly in front of the passenger seat 60. A passenger sitting on the passenger seat 60 of the second train seat module 32 can directly use the table unit 70 in the second seat position of the passenger seat 60.

The passenger seat 40 of the first train seat module 30 in its first seat position and the passenger seat 60 of the second train seat module 32 in its second seat position form a conjoint seat group 80. As a conjoint seat group 80, the passenger seat 40 of the first train seat module 30 in its first seat position and the passenger seat 60 of the second train seat module 32 in its second seat position face towards one another. It is advantageously possible that passengers sitting on the two passenger seats 40, 60 of the two train seat modules 30, 32, which form a conjoint seat group 80, travel together facing towards one another. The table unit 70 arranged between the two train seat modules 30, 32 can be used from both passenger seats 40, 60 of the conjoint seat group 80. It is possible that passengers on both passenger seats 40, 60 of the train seat modules 30, 32, which are combined to form a seat group 80, use the table unit 70 together. The conjoint seat group 80 is at least partially delimited from a remaining portion of the passenger compartment 12 by the two enclosure units 50, 66 of the two train seat modules 30, 32. When combined to form the conjoint seat group 80, the passenger zones of the two train seat modules 30, 32 form a conjoint group passenger zone.

The table base body 72 comprises a first table front edge 82, which is oriented at least substantially orthogonally to the passenger seat 40 of the first train seat module 30 in its first seat position. The first table front edge 82 faces towards the passenger seat 40 of the first train seat module 30 in its first seat position. The table base body 72 has a second table front edge 84, which is oriented at least substantially orthogonally to the passenger seat 40 of the first train seat module 30 in its second seat position. The second table front edge 84 faces towards the passenger seat 60 of the second train seat module 32 in its second seat position.

The table unit 70 comprises a first adjustable table element 86, which is arranged at the table base body 72. The first adjustable table element 86 is adjustable into a use position towards the passenger seat 40 of the first train seat module 30 in its first seat position. The adjustable table element 86 can be stowed at the table base body 72 of the table unit 70 in a stowage position. Preferably the first adjustable table element 86 can be stowed in a region below the table base body 72 in a stowage position. In principle, it is also conceivable that the adjustable table element 86 can be folded onto an upper side of the table base body 72 and there in its stowage position at least partially forms a table surface. The first adjustable table element 86 is arranged in a region of the first table front edge 82. The first adjustable table element 86 is configured to enlarge in a use position the table surface of the table unit 70 towards the passenger seat 40 of the first train seat module 30 in its first seat position.

The table unit 70 comprises a second adjustable table element 88, which is arranged at the table base body 72. The second adjustable table element 88 is adjustable into a use position towards the passenger seat 60 of the second train seat module 32 in its second seat position. The adjustable table element 88 can be stowed at the table base body 72 of the table unit 70 in a stowage position. The second adjustable table element 88 is arranged in a region of the second table front edge 84. The second adjustable table element 88 is configured to enlarge in a use position the table surface of the table unit 70 towards the passenger seat 60 of the second train seat module 32 in its second seat position. The second adjustable table element 88 is realized substantially in the same manner as the first adjustable table element 86.

The train seat layout 10 comprises a foot support element 90. The foot support element 90 is arranged below the table unit 70. The foot support element 90 is configured to provide a foot support region for the passenger seats 40, 60 of the first and second train seat modules 30, 32. The foot support element 90 is arranged below the table unit 70 at a distance. An intermediate space between the foot support element 90 and the table unit 70 is realized as a foot space. The foot support element 90 forms an ottoman for the two passenger seats 40, 60 of the train seat modules 30, 32 in the corresponding seat positions. The foot support element 90 forms an upholstered foot support region. The foot support element 90 forms a foot support region which is shared by both passenger seats and is preferably realized without separation. Preferably, there is no separating element provided which separates a foot support region for the passenger seat 40 of the first train seat module 30 from a foot support region for the passenger seat 60 of the second train seat module 40. In principle, however, a partial separation of the two foot support regions by a preferably adjustable separating element would be entirely conceivable. In a lying-down position of the passenger seats 40, 60 of the train seat modules 30, 32, the foot support element 90 is configured to respectively supplement the lying-down surface of the passenger seats 40, 60. In their lying-down position, the passenger seats 40, 60 of the train seat modules 30, 32 together with the foot support element 90 respectively form their lying-down surface, which in each case has a bed length of at least 170 cm, preferably 180 cm and particularly preferentially of more than 185 cm.

The train seat layout 10 comprises a further table unit 92. Viewed in the second direction 78, the further table unit 92 is arranged after the first train seat module 30. The further table unit 92 is arranged on a first side of the first train seat module 30. The further table unit 92 is arranged on a side of the first train seat module 30 that is situated opposite the first table unit 70. The further table unit 92 is arranged on a side-panel side. The further table unit 92 is arranged in a proximity of the first lateral side panel 16. Preferably the further table unit 92 is directly connected to the first lateral side panel 16. The train seat layout 10 further comprises a further foot support element, which is not illustrated in detail and which is arranged below the further table unit 92.

If the passenger seat 40 of the first train seat module 30 is in its first seat position oriented in the first direction 76, the further table unit 92 is arranged behind the passenger seat 40 of the first train seat module 30. In this position of the passenger seat 40 of the first train seat module 30, the further table unit 92 cannot be used from the passenger seat 40. The passenger seat 40 of the first train seat module 30 in its second seat position directly faces towards the further table unit 92 for use. The further table unit 92 is realized substantially in the same manner as the first table unit 70 that has been described. The further table unit 92 comprises a table base body. The table base body of the further table unit 92 has a first table front edge, which is oriented at least substantially orthogonally to the passenger seat 40 of the first train seat module 30 in its second seat position. The first table front edge of the further table unit 92 faces towards the passenger seat 40 of the first train seat module 30 in its second seat position. Viewed in the first direction 76, the further table unit 92 is realized as a first table unit in the longitudinal seat row. It is therefore principally conceivable that the further table unit 92 has an at least partly different shape, for example only a triangle shape, wherein the further table unit 92 has only one table front edge, which faces towards the passenger seat 40 of the first train seat module 30 in its second seat position.

The train seat layout 10 comprises a stowage and/or deposition unit 108. The stowage and/or deposition unit 108 is arranged laterally next to the passenger seat 40 of the train seat module 30 and is configured to be attached on a side-panel side. The stowage and/or deposition unit 108 provides a stowage region and/or a deposition surface. The stowage and/or deposition unit 108 is arranged between the first table unit 70 and the further table unit 92. The stowage and/or deposition unit 108 is connected to the side panel 16.

The train seat layout 10 comprises a further table unit 94. Viewed in the first direction 76, the further table unit 94 is arranged after the second train seat module 32. The further table unit 94 is arranged on a second side of the second train seat module 32. The further table unit 94 is arranged on a side of the second train seat module 32 that is situated opposite the first table unit 70. The further table unit 94 is arranged on a side-panel side. The further table unit 94 is arranged in a proximity of the first lateral side panel 16. Preferably the further table unit 94 is directly connected to the first lateral side panel 16. The train seat layout 10 moreover comprises a further foot support element, which is not illustrated in detail and which is arranged below the further table unit 94.

If the passenger seat 60 of the second train seat module 32 is in its second seat position oriented in the second direction 78, the further table unit 94 is arranged behind the passenger seat 60 of the second train seat module 32. In this position of the passenger seat 60 of the second train seat module 32, the further table unit 94 cannot be used from the passenger seat 60. The passenger seat 60 of the second train seat module 32 in its first seat position directly faces towards the further table unit 94 for use. In its first seat position, the passenger seat 60 of the second train seat module 32 directly faces towards the further table unit 94. The further table unit 94 is realized substantially in the same manner as the first table unit 70 that has been described. The further table unit 94 comprises a table base body. The table base body of the further table unit 94 has a first table front edge, which is oriented at least substantially orthogonally to the passenger seat 60 of the second train seat module 32 in its first seat position. The first table front edge of the further table unit 94 faces towards the passenger seat 60 of the second train seat module 32 in its first seat position. The further table unit 94 is arranged between the second train seat module 32 and the neighboring train seat module 34. The table base body of the further table unit 94 has a second table front edge, which is oriented at least substantially orthogonally to a passenger seat of the further, third train seat module 34 in its second seat position. The second table front edge of the further table unit 94 faces towards the passenger seat of the further, third train seat module 34 in its second seat position. The further table unit 94 is configured to be used from the passenger seat 60 of the second train seat module 32 and/or from the passenger seat of the further, third train seat module 34. The passenger seat 60 of the second train seat module 32 and the passenger seat of the further, third train seat module 34 can be oriented to form a conjoint seat group, wherein the further table unit 94 is configured for joint use.

In the exemplary embodiment shown, the train seat layout 10 comprises three further table units 96, 98, 100 in the first longitudinal seat row 26. On each side of a train seat module 30, 32, 34, 36, 38 respectively one of the table units 70, 92, 94, 96, 98, 100 is arranged. In each seat position of each passenger seat 40, 60 of each of the train seat modules 30, 32, 34, 36, 38, respectively one of the table units 70, 92, 94, 96, 98, 100 is arranged for use in front of the corresponding passenger seat 40, 60. If two neighboring train seat modules 30, 32, 34, 36, 38 are combined to form a conjoint seat group 80, the table unit 70, 94, 96, 98 arranged between them can be used jointly from both passenger seats 40, 60. The train seat layout 10 comprises per longitudinal seat row 26, 28 respectively one table unit 70, 92, 94, 96, 98, 100 more than train seat modules 30, 32, 34, 36, 38. Due to the rotatable arrangement of the passenger seats 40, 60 of the train seat modules 30, 32, 34, 36, 38 between their first seat positions and their second seat positions and to the arrangement of respectively one table unit 70, 92, 94, 96, 98, 100 on each side of a train seat module 30, 32, 34, 36, 38, it is possible for the train seat modules 30, 32, 34, 36, 38 to be oriented in an advantageously simple manner as an individual train seat module 30, 32, 34, 36, 38 for an individual passenger, or to be combined to form a seat group 80 in which respectively two neighboring train seat modules 30, 32, 34, 36, 38 can jointly use the table unit 70, 94, 96, 98 that is arranged between them. Preferably, between two table units 70, 92, 94, 96, 98, corresponding stowage and/or deposition units 108 are respectively attached on a side-panel side.

The train seat layout 10 comprises at least two further train seat modules 102, 104 and a table unit 106, which are arranged on a second side of the aisle 20 and face towards the second side panel 18. In the exemplary embodiment shown, the train seat layout 10 comprises five further train seat modules 102, 104 and six further table units 106. For reasons of clarity, not all of these are provided with reference numerals in the figures. The further train seat modules 102, 104 and table units 106 form the second longitudinal seat row 28 of the train seat layout 10. The further train seat modules 102, 104 and table units 106 of the second longitudinal seat row 28 are realized identically to the above-described train seat modules 30, 32, 34, 36, 38 and table units 70, 92, 94, 96, 98, 100, therefore they will not be described in detail here. In the exemplary embodiment shown, the two longitudinal seat rows 26, 28 comprise identical numbers of train seat modules 30, 32, 34, 36, 38, 102, 104 and table units 70, 92, 94, 96, 98, 100, 106. In principle, however, it is also conceivable that the two longitudinal seat rows 26, 28 respectively comprise different numbers of train seat modules 30, 32, 34, 36, 38, 102, 104 and table units 70, 92, 94, 96, 98, 100, 106.

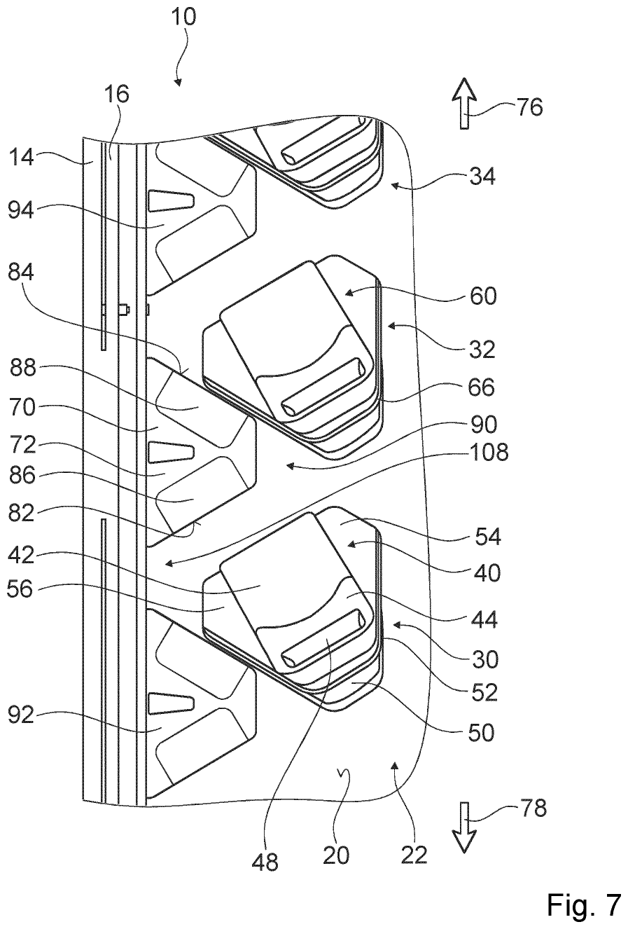

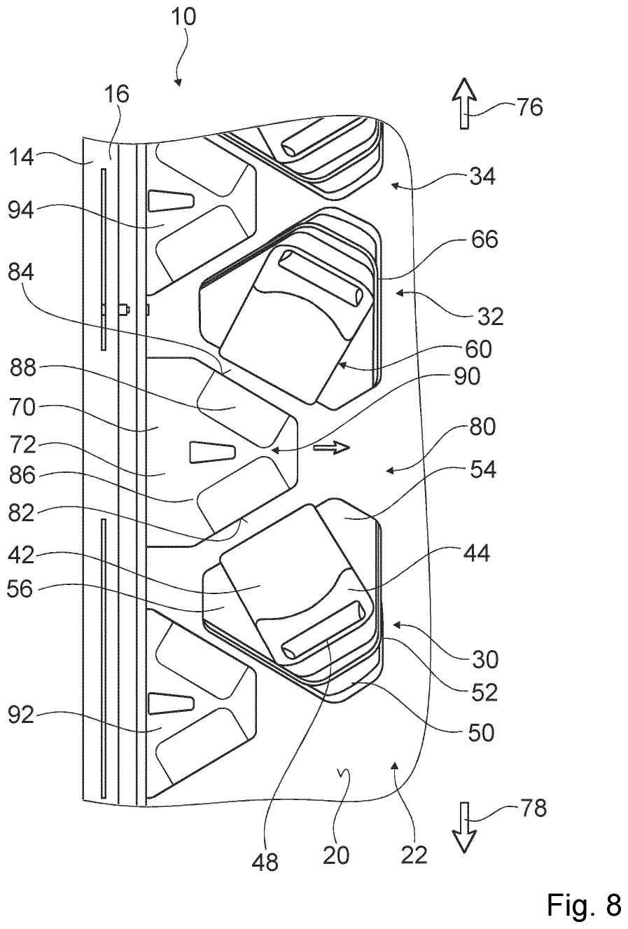

An alternative implementation of the table unit 70 is illustrated in FIG. 8. In the alternative implementation of the table unit 70, the table unit 70 has an extendable table base body 72. The extendable table base body 72 is movably connected on a side-panel side. The table base body 72 is extendably fastened to the side panel 16. The extendable table base body 72 is configured to be traversed in a transverse direction of the passenger compartment 14 between a retracted position and a deployed position. The table base body is displaceable in the transverse direction in the direction of the arrow shown in FIG. 8. Here the table base body 72 is shown in the deployed position in FIG. 8. In the deployed position, the table base body 72 is traversed with its table front edges 82, 84 into a proximity in front of the passenger seats 40, 60 of the train seat modules 30, 32. In the retracted position, the table base body 72 is arranged in a manner equivalent to the position of the firmly fixed implementation illustrated in FIG. 7. The table unit 70 comprises a bearing unit, which is not illustrated in detail and via which the table base body 72 is adjustably supported. The bearing unit is preferably realized as a linear bearing unit. The table base body 72 is lockable in the retracted position and in the deployed position. For locking, the table unit 70 comprises a locking unit, which is not illustrated in detail. In principle, it would also be conceivable that the table base body 72 of the table unit 70 is steplessly lockable in any position between the retracted position and a maximally deployed position.

Furthermore, it is alternatively also conceivable that the table base body 72 of the table unit 70 is not adjustable and in principle has a basic shape as illustrated in FIG. 8. The table base body 72 of the table unit 70 herein comprises, on a side-panel side, a rectangular subregion in which the table base body 72 extends away from the side panel 16 in the transverse direction. The above-described triangular or trapezoid basic shape of the table base body 72 adjoins the rectangular subregion. In such an implementation, a distance between the passenger seats 40, 60 of the train seat modules 30, 32 would have to be increased relative to the above-described implementation with a smaller table unit.

1. A train seat layout with a first train seat module comprising a passenger seat and with a second train seat module comprising a passenger seat, the train seat modules being arranged adjacently in a longitudinal seat row on a side of an aisle in a passenger compartment, and with a table unit which is configured to be mounted on a side-panel side and is arranged between the first train seat module and the second train seat module, wherein the passenger seats of the train seat modules are in each case configured to be pivotable between a first seat position, which is oriented in a first direction, and a second seat position, which is oriented in a second direction, wherein the passenger seat of the first train seat module in its first seat position directly faces towards the table unit for use, and the passenger seat of the second train seat module in its second seat position directly faces towards the table unit for use.

2. The train seat layout according to claim 1, wherein the passenger seats are configured to be pivoted between their first seat position and their second seat position by an angle that is in an angle range of 90 degrees to 135 degrees.

3. The train seat layout according to claim 1, wherein the passenger seat of the first train seat module in its first seat position and the passenger seat of the second train seat module in its second seat position form a conjoint seat group, wherein the table unit arranged between them can be used from both passenger seats of the conjoint seat group.

4. The train seat layout according to claim 1, wherein the table unit comprises a table base body forming a main table surface and having a first table front edge that is oriented at least substantially orthogonally to the passenger seat of the first train seat module in its first seat position, and having a second table front edge that is oriented at least substantially orthogonally to the passenger seat of the second train seat module in its second seat position.

5. The train seat layout according to claim 4, wherein in a top view the table base body essentially has a trapezoid shape or a triangle shape.

6. The train seat layout according to claim 1, wherein the table unit comprises a first adjustable table element, which is arranged at the table base body and is adjustable into a use position towards the passenger seat of the first train seat module in its first seat position, and/or comprises a second adjustable table element, which is arranged at the table base body and is adjustable into a use position towards the passenger seat of the second train seat module in its second seat position.

7. The train seat layout according to claim 1, further comprising a further table unit, which is arranged after the first train seat module in the second direction, wherein the passenger seat of the first train seat module in its second seat position directly faces towards the further table unit for use.

8. The train seat layout according to claim 1, further comprising a further table unit, which is arranged after the second train seat module in the first direction, wherein the passenger seat of the second train seat module in its first seat position directly faces towards the further table unit for use.

9. The train seat layout according to claim 1, wherein the passenger seat of the train seat module is realized as a lying-down seat which is adjustable between a sitting position and at least a lying-down position.

10. The train seat layout according to claim 1, further comprising a foot support element, which is arranged below the table unit and is configured to provide a foot support region for the passenger seats of the first and second train seat modules.

11. The train seat layout according to claim 1, wherein the passenger seat of the train seat module is realized as a full-flat lying-down seat and is configured to provide an at least substantially planar lying-down surface with a bed length of at least 170 cm.

12. The train seat layout according to claim 1, further comprising a stowage and/or deposition unit, which is arranged laterally next to the passenger seat of the train seat module and is configured to be attached on a side-panel side and to provide a stowage region and/or a deposition surface.

13. The train seat layout according to claim 1, wherein the passenger seats of the train seat modules are in each case configured to be oriented towards a side-panel side in their seat positions.

14. The train seat layout according to claim 1, wherein the train seat module comprises an enclosure unit, which at least partially delimits the one passenger zone of the train seat module behind and laterally of the passenger seat, and which is configured to be pivoted together with the passenger seat during an adjustment between the first seat position and the second seat position.

15. The train seat layout according to claim 1, further comprising at least two further train seat modules and a table unit, which are arranged on a second side of the aisle of the passenger compartment and face towards a second side panel.
